(19) United States
(12) Patent Application Publication
(10) Pub. No.: US 2006/0292450 A1
(43) Pub. Date: Dec. 28, 2006

(54) Non-aqueous electrolyte secondary battery

(75) Inventors: Shinji Nakanishi, Osaka (JP); Hizuru Koshina, Palo Alto, CA (US)

Correspondence Address: PANASONIC PATENT CENTER;c/o MCDERMOTT WILL & EMERY LLP, 600 13TH STREET, NW, WASHINGTON, DC, 20005-3096, US

(73) Assignee: Matsushita Electric Industrial Co., Ltd.

(21) Appl. No.: 11/177,600

(22) Filed: Jul. 11, 2005

(30) Foreign Application Priority Data
Jul. 13, 2004 (JP) 2004-205672

(51) Int. Cl. H01M 10/40

(52) U.S. Cl. 429/326; 429/328

(57) ABSTRACT

The present invention provides a highly-reliable non-aqueous electrolyte secondary battery excellent in safety. The non-aqueous electrolyte secondary battery includes an electrode group, a non-aqueous electrolyte and a case accommodating the electrode group and the non-aqueous electrolyte. The non-aqueous electrolyte contains a specific bromine compound having an aromatic ring.

### FIELD OF THE INVENTION

The present invention relates to a highly-reliable non-aqueous electrolyte secondary battery whose electrolyte contains a specific bromine compound having an aromatic ring.

### BACKGROUND OF THE INVENTION

Non-aqueous electrolyte secondary batteries including a lithium ion secondary battery, which have high energy density, can be made smaller and lighter. Generally, non-aqueous electrolyte secondary batteries have the structure described below.

A non-aqueous electrolyte secondary battery has an electrode group, a non-aqueous electrolyte and a case containing the electrode group and the non-aqueous electrolyte. The electrode group has a positive electrode, a negative electrode and a separator (insulating layer) interposed between the positive electrode and the negative electrode. In most cases, the positive and negative electrodes are spirally-wound with the separator interposed therebetween.

The positive electrode comprises a positive electrode current collector and a positive electrode material mixture layer carried on the positive electrode current collector. The negative electrode comprises a negative electrode current collector and a negative electrode material mixture layer carried on the negative electrode current collector. The positive electrode material mixture contains a positive electrode active material. The positive electrode active material is usually composed of a composite metal oxide. Particularly, a lithium-containing transition metal oxide such as lithium cobalt oxide (LiCoO₂) is used. The negative electrode material mixture contains a negative electrode active material. The negative electrode active material is composed of a material capable of absorbing and desorbing lithium ions, for example, a carbon material such as graphite.

The separator is usually a microporous membrane made of a polyolefin resin such as polyethylene or polypropylene. A polymer membrane containing polyethylene oxide, polyvinylidene fluoride or polyacrylate is also used as the separator.

As the non-aqueous electrolyte, a non-aqueous solvent having a solute dissolved therein, a gel electrolyte, etc are used. The gel electrolyte is obtained by allowing a non-aqueous solvent having a solute dissolved therein to be retained in a polymer matrix (network structure). The solute is usually a lithium salt such as lithium hexafluorophosphate (LiPF₆). Although there are a variety of non-aqueous solvents, usually, one containing a carbonic acid ester such as ethylene carbonate or dimethyl carbonate is used.

Because the non-aqueous electrolyte is flammable, there is a need to ensure safety. For this reason, for example, a high capacity lithium ion secondary battery is usually equipped with a protection circuit for preventing overcharge and overdischarge.

The non-aqueous electrolyte secondary battery can charge to a high voltage, and therefore provides a high energy density. However, because it has a high voltage and a high energy density, the decomposition due to oxidation of the non-aqueous electrolyte on the positive electrode is likely to occur. As for the negative electrode, the decomposition due to reduction of the non-aqueous electrolyte is likely to occur because the negative electrode has a very low electrochemical potential. Since these decomposition reactions tend to occur at high temperatures, a large amount of gas is generated when the battery is stored at a high temperature of 60 to 85° C.

The non-aqueous electrolyte secondary battery is used as a power source for driving electronics such as a laptop computer. The temperature inside the laptop computer is usually 45 to 60° C. Under such temperature conditions, the battery is charged at a constant voltage of 4.2 V, and the battery in a charged state is sometimes maintained for a long period of time. When a charged battery is stored at high temperatures, gas is more likely to be generated inside the battery than the case where a battery in an open circuit condition is stored at high temperatures. If the pressure inside the battery increases due to generation of gas during high temperature storage, the protection circuit will operate to shut the current, losing the function of the battery.

In an attempt to improve the battery characteristics during high temperature storage, Japanese Laid-Open Patent Publication No. Hei 6-231753 proposes a battery whose positive electrode contains a bromine compound. Further, in an attempt to prevent the acceleration of temperature increase due to heating of an electrode when the battery temperature is increased to a high temperature in overcharge test or the like, the addition of a flame retardant, that is, a bromine compound having an aromatic ring to an electrode is proposed. For example, Japanese Laid-Open Patent Publication No. Hei 10-172615 proposes a battery whose electrode contains a bromine compound. Japanese Patent No. 3305035 proposes a battery in which a flame retardant that is in a liquid state at room temperature such as hexabromobenzene is added to the non-aqueous electrolyte.

The incorporation of the flame retardant into an electrode prevents the acceleration of temperature increase of the battery. Further, the addition of hexabromobenzene or the like to the non-aqueous electrolyte yields the effect of improving safety.

However, the incorporation of the flame retardant into an electrode is accompanied by the problem that the flame retardant acts as a resistance element and the electrode resistance significantly increases. Moreover, although the flame retardant is considered to form, on the electrode, a film capable of preventing the generation of gas, it is difficult to efficiently produce the film when the flame retardant is contained in the electrode. Accordingly, the effect of preventing the generation of gas cannot be obtained in some cases. Further, when an electrode contains a bromine compound which serves as an insulation, it serves as an inhibiting factor in diffusion of electrons or ions, in other words, in charge transfer reaction, resulting in lower cycle life characteristics. Even when hexabromobenzene or the like is added to the non-aqueous electrolyte, a favorable film cannot be produced on an electrode.

### BRIEF SUMMARY OF THE INVENTION

An object of the present invention is to provide a highly-reliable non-aqueous electrolyte secondary battery in which, while the effect of preventing the temperature increase of the battery is maintained, the amount of gas generated inside the battery is small even when the battery in a charged state is stored at high temperatures, and the battery exhibits excellent battery characteristics after storage as well as cycle characteristics.

More specifically, the present invention relates to a non-aqueous electrolyte secondary battery comprising an electrode group, a non-aqueous electrolyte and a case accommodating the electrode group and the non-aqueous electrolyte, the electrode group comprising a positive electrode, a negative electrode and a separator interposed between the positive electrode and the negative electrode, the non-aqueous electrolyte comprising a bromine compound having an aromatic ring, wherein

the bromine compound is represented by any one of the following chemical formulas (1) to (17):

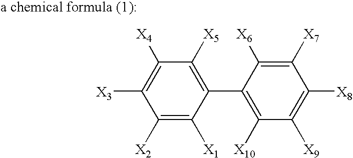

where X₁ to X₁₀ each independently represent a bromine atom or hydrogen atom, and at least one of them is a bromine atom;

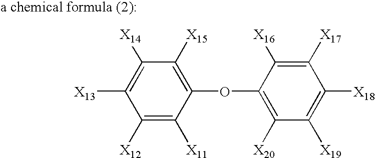

where X₁₁ to X₂₀ each independently represent a bromine atom or hydrogen atom, and at least one of them is a bromine atom;

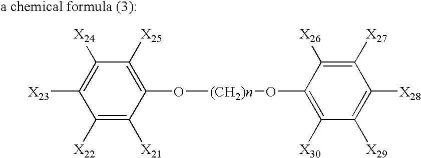

where X₂₁ to X₃₀ each independently represent a bromine atom or hydrogen atom, and at least one of them is a bromine atom, and where n is 1 to 4;

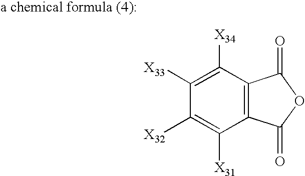

where X₃₁ to X₃₄ each independently represent a bromine atom or hydrogen atom, and at least one of them is a bromine atom;

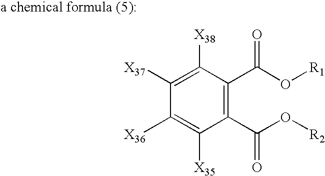

where X₃₅ to X₃₈ each independently represent a bromine atom or hydrogen atom, and at least one of them is a bromine atom, and where R₁ and R₂ are each independently a group containing a carbon atom and at least one selected from the group consisting of hydrogen atom and oxygen atom, and the number of the carbon atoms is 1 to 6;

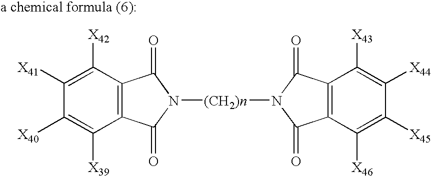

where X₃₉ to X₄₆ each independently represent a bromine atom or hydrogen atom, and at least one of them is a bromine atom, and where n is 0 to 4;

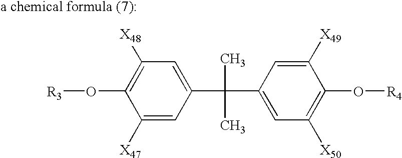

where X₄₇ to X₅₀ each independently represent a bromine atom or hydrogen atom, and at least one of them is a bromine atom, and where R₃ and R₄ are each independently a group containing a carbon atom, a hydrogen atom and at least one selected from the group consisting of bromine atom and oxygen atom, and the number of the carbon atoms is 1 to 6;

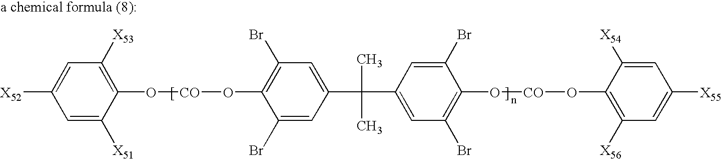

where X₅₁ to X₅₆ each independently represent a bromine atom or hydrogen atom, and at least one of them is a bromine atom, and where n is 2 to 10;

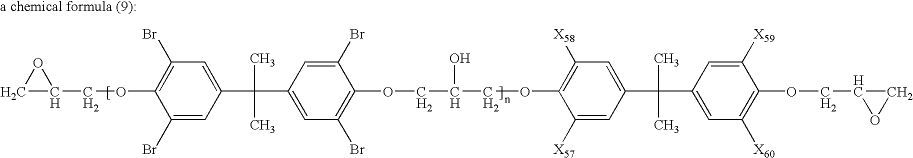

where X₅₇ to X₆₀ each independently represent a bromine atom or hydrogen atom, and at least one of them is a bromine atom, and where n is 1 to 100;

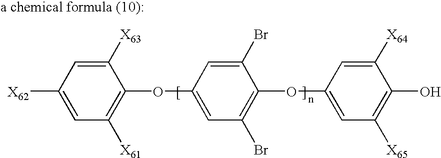

where X₆₁ to X₆₅ each independently represent a bromine atom or hydrogen atom, and at least one of them is a bromine atom, and where n is 10 to 30;

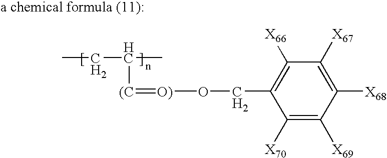

where X₆₆ to X₇₀ each independently represent a bromine atom or hydrogen atom, and at least one of them is a bromine atom, and where n is 100 to 200;

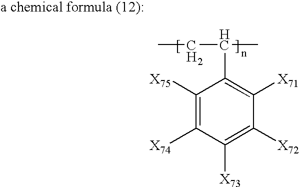

where X₇₁ to X₇₅ each independently represent a bromine atom or hydrogen atom, and at least one of them is a bromine atom, and where n is 200 to 600;

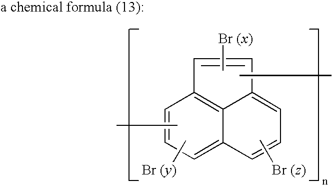

where x, y and z each represent the number of bromine atoms bonded to an aromatic ring, and the total of x, y and z is 1 to 6, and where n is 1 to 5;

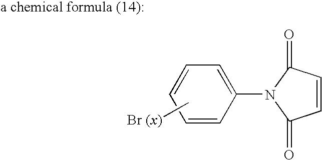

where x represents the number of bromine atoms bonded to an aromatic ring, and x is 1 to 5;

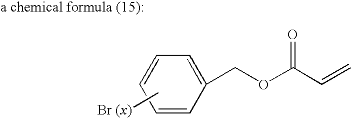

where x represents the number of bromine atoms bonded to an aromatic ring, and x is 1 to 5;

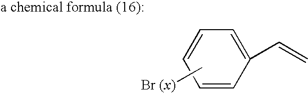

where x represents the number of bromine atoms bonded to an aromatic ring, and x is 1 to 5; and

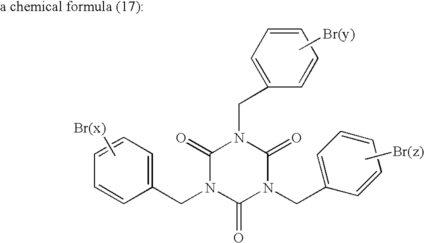

where x, y and z each represent the number of bromine atoms bonded to an aromatic ring, and x, y and z are each 1 to 5.

The amount of bromine atoms contained in the bromine compound having an aromatic ring (i.e. the amount of bromine atoms contained in the bromine compound having an aromatic ring to be added to the non-aqueous electrolyte during the production of the battery) is preferably 0.003 to 0.1 mol/L relative to the amount of the non-aqueous electrolyte, more preferably, 0.003 to 0.05 mol/L relative to the same.

The effect of preventing the battery temperature from increasing can be obtained by adding the bromine compound having an aromatic ring listed above to the non-aqueous electrolyte. When the battery in a charged state is stored at high temperatures, it is also possible to prevent the generation of gas. Moreover, the battery exhibits excellent battery characteristics after storage as well as cycle life characteristics. Therefore, according to the present invention, it is possible to provide a highly-reliable non-aqueous electrolyte secondary battery excellent in safety.

While the novel features of the invention are set forth particularly in the appended claims, the invention, both as to organization and content, will be better understood and appreciated, along with other objects and features thereof, from the following detailed description taken in conjunction with the drawings.

### BRIEF DESCRIPTION OF THE SEVERAL VIEWS OF THE DRAWING

FIG. 1 is a front view, partially in cross section, of a cylindrical lithium ion secondary battery in accordance with the present invention.

### DETAILED DESCRIPTION OF THE INVENTION

Examples of the non-aqueous electrolyte secondary battery of the present invention include a lithium ion secondary battery, a polymer secondary battery using a gel electrolyte, a magnesium secondary battery, an aluminum secondary battery and sodium secondary battery. There is no specific limitation on the shape and package of the non-aqueous electrolyte secondary battery.

The non-aqueous electrolyte secondary battery of the present invention has an electrode group, a non-aqueous electrolyte, and a case accommodating the electrode group and the non-aqueous electrolyte.

The electrode group has a positive electrode, a negative electrode and a separator interposed between the positive electrode and the negative electrode. The electrode group may a columnar electrode group in which a positive electrode and a negative electrode are spirally wound with a separator interposed therebetween or an electrode group in which a plurality of positive electrodes and a plurality of negative electrodes are stacked with separators interposed therebetween.

The non-aqueous electrolyte contains a non-aqueous solvent dissolving a solute therein. The solute is preferably an alkali metal salt. For example, a fluorine-containing inorganic anion salt or a lithium imide salt can be used. Examples of the fluorine-containing inorganic anion salt include LiPF₆, LiBF₄, LiAsF₆, LiSbF₆, NaPF₆ and NaBF₄. Examples of the lithium imide salt include LiN(CF₃SO₂)₂, LiN(C₂F₅SO₂)₂, LiN(CF₃SO₂)(C₄F₉SO₂) and LiN(CF₃SO₂)₂. The solute may be used singly or in any combination of two or more.

As the non-aqueous solvent, there can be used a cyclic carbonic acid ester, a non-cyclic carbonic acid ester, a lactone or its derivative, a furan or its derivative, an ether or its derivative, a glyme or its derivative, an amide, an alcohol, an ester, a phosphoric acid or phosphoric acid ester, dimethyl sulfoxide, sulfolane or its derivative, dioxolane or its derivative, etc. The non-aqueous solvent may be used singly, and preferably it is used in any combination of two or more.

As the cyclic carbonic acid ester, there are, for example, propylene carbonate, ethylene carbonate, butylene carbonate and vinylene carbonate. As the non-cyclic carbonic acid ester, there are, for example, dimethyl carbonate, diethyl carbonate and methyl ethyl carbonate. As the lactone or its derivative, there are γ-butyrolactone, γ-valerolactone and δ-valerolactone, for example. As the furan or its derivative, there are, for example, tetrahydrofuran and 2-methyltetrahydrofuran. As the ether or its derivative, there are, for example, 1,2-dimethoxyethane and 1,2-diethoxyethane. As the glyme or its derivative, there are, for example, diglyme, triglyme and tetraglyme. As the amide, there are, for example, n,n-dimethylformamide and n-methylpyrrolidinone. As the alcohol, there are, for example, ethyleneglycol and propyleneglycol. As the ester, there are, for example, methyl acetate, ethyl acetate, methyl propionate and ethyl propionate.

The non-aqueous solvent may contain any additive that has conventionally been used, such as cyclohexylbenzene or propanesultone.

The case accommodating the electrode group and the non-aqueous electrolyte can be, for example, a metal battery can having any shape or a case made of an aluminum laminate film having any shape. The aluminum laminate film is prepared by bonding an aluminum foil and a resin film.

The non-aqueous electrolyte in the non-aqueous electrolyte secondary battery of the present invention contains a bromine compound having an aromatic ring. The bromine compound having an aromatic ring is represented by any one of the formulas (1) to (17). The bromine compounds represented by the formulas (1) to (17) may be used singly or in any combination of two or more.

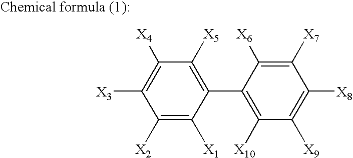

where X₁ to X₁₀ each independently represent a bromine atom or hydrogen atom, and at least one of them is a bromine atom.

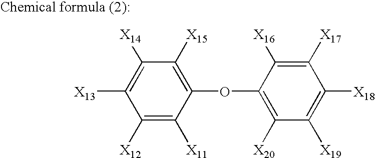

where X₁₁ to X₂₀ each independently represent a bromine atom or hydrogen atom, and at least one of them is a bromine atom.

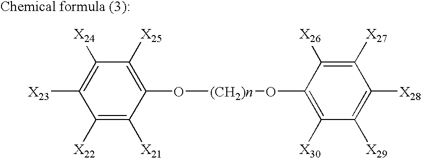

where X₂₁ to X₃₀ each independently represent a bromine atom or hydrogen atom, and at least one of them is a bromine atom, and where n is 1 to 4.

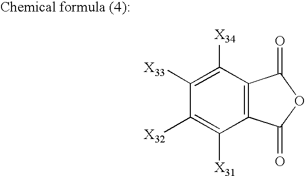

where X₃₁ to X₃₄ each independently represent a bromine atom or hydrogen atom, and at least one of them is a bromine atom.

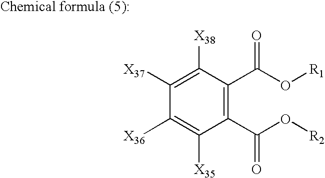

where X₃₅ to X₃₈ each independently represent a bromine atom or hydrogen atom, and at least one of them is a bromine atom, and where R₁ and R₂ are each independently a group containing a carbon atom and at least one selected from the group consisting of hydrogen atom and oxygen atom, and the number of the carbon atoms is 1 to 6.

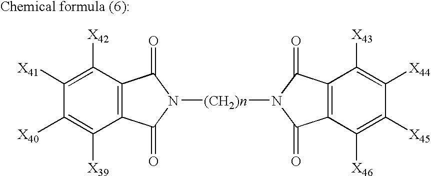

where X₃₉ to X₄₆ each independently represent a bromine atom or hydrogen atom, and at least one of them is a bromine atom, and where n is 0 to 4.

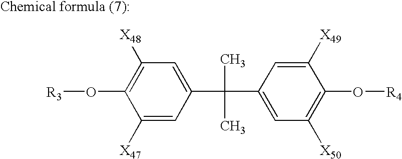

where X₄₇ to X₅₀ each independently represent a bromine atom or hydrogen atom, and at least one of them is a bromine atom, and where R₃ and R₄ are each independently a group containing a carbon atom, a hydrogen atom and at least one selected from the group consisting of bromine atom and oxygen atom, and the number of the carbon atoms is 1 to 6.

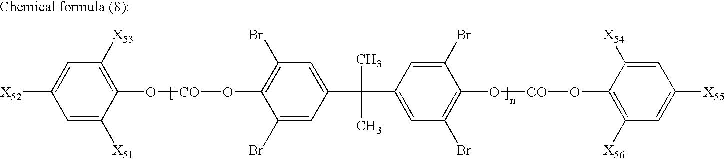

where X₅₁ to X₅₆ each independently represent a bromine atom or hydrogen atom, and at least one of them is a bromine atom, and where n is 2 to 10.

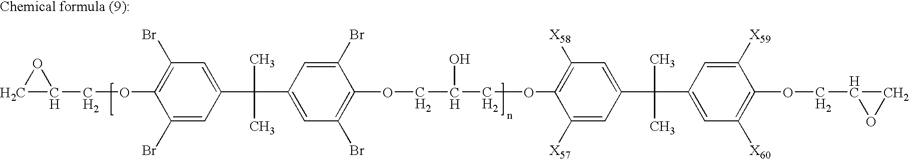

where X₅₇ to X₆₀ each independently represent a bromine atom or hydrogen atom, and at least one of them is a bromine atom, and where n is 1 to 100.

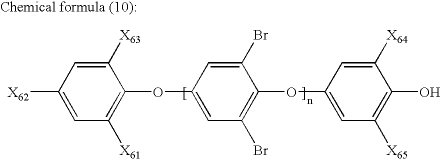

where X₆₁ to X₆₅ each independently represent a bromine atom or hydrogen atom, and at least one of them is a bromine atom, and where n is 10 to 30.

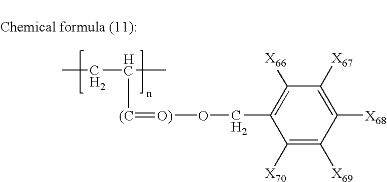

where X₆₆ to X₇₀ each independently represent a bromine atom or hydrogen atom, and at least one of them is a bromine atom, and where n is 100 to 200.

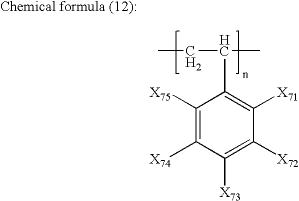

where X₇₁ to X₇₅ each independently represent a bromine atom or hydrogen atom, and at least one of them is a bromine atom, and where n is 200 to 600.

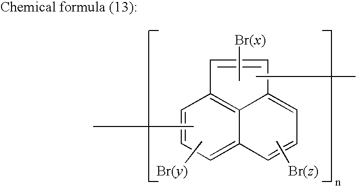

where x, y and z each represent the number of bromine atoms bonded to an aromatic ring, and the total of x, y and z is 1 to 6, and where n is 1 to 5.

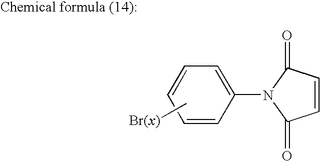

where x represents the number of bromine atoms bonded to an aromatic ring, and x is 1 to 5.

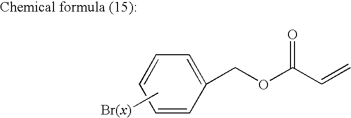

where x represents the number of bromine atoms bonded to an aromatic ring, and x is 1 to 5.

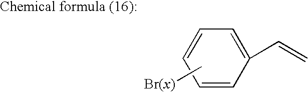

where x represents the number of bromine atoms bonded to an aromatic ring, and x is 1 to 5.

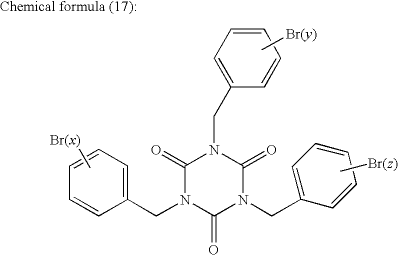

where x, y and z each represent the number of bromine atoms bonded to an aromatic ring, and x, y and z are each 1 to 5.

The bromine compounds represented by the formulas (1) to (3) are biphenyl compounds in which hydrogen atoms are at least partially replaced with bromine atoms.

Specific examples of the bromine compound represented by the formula (1) include decabromodiphenyl, nonabromodiphenyl, octabromodiphenyl, heptabromodiphenyl, hexabromodiphenyl, pentabromodiphenyl, tetrabromodiphenyl, tribromodiphenyl, dibromodiphenyl and monobromodiphenyl. They may be used singly or in any combination of two or more.

Specific examples of the bromine compound represented by the formula (2) include decabromodiphenyl ether, nonabromodiphenyl ether, octabromodiphenyl ether, heptabromodiphenyl ether, hexabromodiphenyl ether, pentabromodiphenyl ether, tetrabromodiphenyl ether, tribromodiphenyl ether, dibromodiphenyl ether and monobromodiphenyl ether. They may be used singly or in any combination of two or more.

Specific examples of the bromine compound represented by the formula (3) include decabromodiphenoxy ethane, nonabromodiphenoxy ethane, octabromodiphenoxy ethane, heptabromodiphenoxy ethane, hexabromodiphenoxy ethane, pentabromodiphenoxy ethane, tetrabromodiphenoxy ethane, tribromodiphenoxy ethane, dibromodiphenoxy ethane, hexabromodiphenoxy methane, hexabromodiphenoxy propane and hexabromodiphenoxy butane. They may be used singly or in any combination of two or more.

The bromine compounds represented by the formulas (4) to (6) are phthalic anhydride-based compounds.

Specific examples of the bromine compound represented by the formula (4) include tetrabromophthalic anhydride, tribromophthalic anhydride, dibromophthalic anhydride and monobromophthalic anhydride.

The bromine compound represented by the formula (5) is a diester compound of tetrabromophthalic acid, tribromophthalic acid, dibromophthalic acid or monobromophthalic acid. R₁ and R₂ may be any group.

Specific examples of the bromine compound represented by the formula (6) include bistetrabromo phthalimide, methylene bistetrabromo phthalimide, ethylene bistetrabromo phthalimide, propylene bistetrabromo phthalimide, butylene bistetrabromo phthalimide, ethylene bistribromo phthalimide, ethylene bisdibromo phthalimide and ethylene bismonobromo phthalimide.

The bromine compound represented by the formula (7) is a bisphenol A-based compound.

Specific examples of the bromine compound represented by the formula (7) include tetrabromobisphenol A-bis-(2,3-dibromopropyl ether), tetrabromobisphenol A-bis-(2-hydroxyethyl ether), tetrabromobisphenol A-bis-(allyl ether), dibromobisphenol A-bis-(2,3-dibromopropyl ether) and dibromobisphenol A-bis-(2-hydroxyethyl ether).

The bromine compound represented by the formula (8) is a carbonate oligomer containing, in the main skeleton, tetrabromobisphenol A structure. The bromine compound represented by the formula (8) can be any of a variety of types thereof.

The bromine compound represented by the formula (9) is an epoxy resin containing, in the main skeleton, tetrabromobisphenol A structure. The bromine compound represented by the formula (9) can be any of a variety of types thereof. For example, compounds represented by the formula (9), where n is 1 to 6, about 65, about 80 or about 100 are commercially readily available.

The bromine compounds represented by the formulas (10) to (13) are oligomers or polymers containing a benzene ring in which hydrogen atoms are at least partially replaced with bromine atoms.

The bromine compound represented by the formula (10) is polydibromophenylene oxide and any of a variety of types thereof. For example, there are compounds represented by the formula (10), where n is about 10, about 20 or about 30. They are commercially readily available.

A specific example of the bromine compound represented by the formula (11) is poly(pentabromobenzyl)acrylate. For example, there are compounds represented by the formula (11), where n is about 100, about 140 or about 200. They are commercially readily available.

Specific examples of the bromine compound represented by the formula (12) include polypentabromostyrene, polytetrabromostyrene, polytribromostyrene, polydibromostyrene and polymonobromostyrene. There are various compounds represented by the formula (12) by changing the value of n which represents the degree of polymerization. Examples thereof include the compounds where n is about 200, about 320, about 440 and about 600. They are commercially readily available.

A specific example of the bromine compound represented by the formula (13) is polybrominated acetonaphthylene. There are various compounds represented by the formula (13) by changing the values of n which represents the degree of polymerization, and x, y and z. For example, the compounds, where n is 2 to 5, are commercially readily available.

The bromine compounds represented by the formulas (14) to (16) are compounds having one benzene ring in which hydrogen atoms are at least partially replaced with bromine atoms.

Specific examples of the bromine compound represented by the formula (14) include monobromophenyl maleimide, dibromophenyl maleimide, tribromophenyl maleimide, tetrabromophenyl maleimide and pentabromophenyl maleimide.

Specific examples of the bromine compound represented by the formula (15) include monobromobenzyl acrylate, dibromobenzyl acrylate, tribromobenzyl acrylate, tetrabromobenzyl acrylate and pentabromobenzyl acrylate.

Specific examples of the bromine compound represented by the formula (16) include monobromostyrene, dibromostyrene, tribromostyrene, tetrabromostyrene and pentabromostyrene.

The bromine compound represented by the formula (17) is a compound having an isocyanurate structure and three benzene rings in which hydrogen atoms are at least partially replaced with bromine atoms.

Specific examples of the bromine compound represented by the formula (17) include tris(monobromobenzyl)isocyanurate, tris(dibromobenzyl)isocyanurate, tris(tribromobenzyl)isocyanurate, tris(tetrabromobenzyl)isocyanurate, tris(pentabromobenzyl)isocyanurate, bis(pentabromobenzyl)mono(tribromobenzyl)isocyanurate and mono(monobromobenzyl)mono(tribromobenzyl)mono(pentabromobenzyl)isocyanurate.

Hereinafter, a description will be given of the action of the bromine compound having an aromatic ring.

The bromine compound having an aromatic ring is considered to produce a film containing an aromatic ring and a bromine atom (film containing a decomposed component of the bromine compound) on the surface of the negative electrode active material and that of the positive electrode active material during the initial charging for activating the battery. Since this film is stable, the decomposition reaction of the non-aqueous electrolyte is unlikely to occur even when the battery is stored in a charged state. Accordingly, it is considered that the generation of gas is prevented. Further, since this film contains bromine, it has the effect of flame resistance, and therefore it is possible to prevent the battery temperature from increasing during overcharge or internal short circuit.

In the case of using a bromine compound without an aromatic ring, although the effect of flame resistance can be obtained, the effect of preventing gas generation cannot be obtained, or the effect will be extremely small as compared to the case where a bromine compound having an aromatic ring is used. In other words, the prevention of gas generation is a typical effect obtained only in the case of using a bromine compound having an aromatic ring. Presumably, this is relevant to the fact that the film containing a decomposed component of the bromine compound contains an aromatic ring.

In order to produce a film containing an aromatic ring and a bromine atom (film containing a decomposed component of the bromine compound) on the surface of the negative electrode active material and that of the positive electrode active material during the initial charge for activating the battery, the bromine compound having an aromatic ring should exist near the active material surface. As such, the bromine compound needs to exist in a mobile state. For this reason, it is most effective, from the viewpoint of forming the film, that the bromine compound be added to the non-aqueous electrolyte.

Even in the case of using a gel electrolyte in which a non-aqueous solvent having a solute dissolved therein is retained in a polymer matrix (network structure), because the bromine compound can move to a certain degree in the gel electrolyte, it is possible to form a film containing a sufficient amount of a decomposed component of the bromine compound. For example, a gel electrolyte containing a bromine compound having an aromatic ring is obtained by allowing a non-aqueous solvent having a solute dissolved therein and a bromine compound having an aromatic ring added thereto to be retained in a polymer matrix. Alternatively, a gel electrolyte can be obtained by mixing a monomer solution, as a raw material of polymer matrix, with a non-aqueous solvent having a solute dissolved therein and a bromine compound having an aromatic ring added thereto, and polymerizing the monomer.

The bromine compound is preferably contained in the non-aqueous electrolyte such that the total number of moles of bromine atoms is 0.003 to 0.1 mol/L relative to the amount of the non-aqueous electrolyte. When the amount of bromine atoms relative to that of the non-aqueous electrolyte is less than 0.003 mol/L, the amount of gas generated during high temperature storage will be large, or the discharge characteristics of the battery after storage might be degraded. Conversely, when the amount of bromine atoms relative to that of the non-aqueous electrolyte is greater than 0.1 mol/L, the amount of gas generated during high temperature storage will be suppressed, but, because a relatively large amount of the bromine compound will exist in the non-aqueous electrolyte, the bromine compound will act as a resistance element, which might degrade the rapid discharge characteristics. Accordingly, the bromine compound is preferably contained in the non-aqueous electrolyte such that the concentration of bromine atoms is 0.003 to 0.1 mol/L relative to the amount of the non-aqueous electrolyte.

The bromine compound may be completely dissolved in the non-aqueous electrolyte, and it may not be completely dissolved but just dispersed in the same. Even when the bromine compound is not completely dissolved but just dispersed in the non-aqueous electrolyte, it will not act much as a resistance element, and therefore there will be no effect on the battery characteristics.

As the separator, preferably used is a microporous membrane prepared by forming a resin or resin compound into a sheet, followed by further drawing. Such raw material resin for the separator is not specifically limited. Examples thereof include polyolefin resins such as polyethylene and polypropylene, polyamide, polyethylene terephthalate (PET), polyamideimide and polyimide. Particularly preferred is a polyolefin microporous membrane.

The positive electrode active material is not specifically limited, and preferably used is a lithium-containing transition metal oxide such as lithium cobalt oxide (LiCoO₂), lithium nickel oxide (LiNiO₂), lithium manganese oxide (LiMn₂O₄, LiMnO₂) or lithium iron oxide (LiFeO₂). A composite oxide obtained by partially replacing the transition metal of the above listed lithium-containing transition metal oxide with other transition metal or a typical metal such as tin or aluminum is also preferably used. Other than the above, a lithium compound having an olivine structure, a transition metal oxide, a transition metal sulfide, or a polymer can be used as the positive electrode active material. Examples of the lithium compound having an olivine structure include lithium iron phosphate (LiFePO₄), lithium manganese phosphate (LiMnPO₄) and lithium cobalt phosphate (LiCoPO₄). Examples of the transition metal oxide include vanadium oxide (V₂O₅), manganese oxide (MnO₂) and molybdenum oxide (MoO₂). Examples of the transition metal sulfide include iron sulfate (FeSO₄), titanium sulfide (TiS₂), molybdenum sulfide (MOS₂, MOS₃) and iron sulfide (FeS₂). Examples of the polymer include polyaniline, polypyrrole and polythiophene. The positive electrode active material may be used singly or in any combination of two or more.

The negative electrode active material is not specifically limited. There can be used a material capable of absorbing and desorbing alkali metal ions such as lithium ions or sodium ions, or a material capable of forming an alloy with alkali metal ions. Examples of the material capable of absorbing and desorbing alkali metal ions include a carbon material, a metal oxide and an intermetallic compound. Examples of the carbon material include amorphous carbon, artificial graphite and natural graphite. Examples of the metal oxide include oxides of lead (Pb), tin (Sn), bismuth (Bi) and silicon (Si). As the intermetallic compound, there is a compound in which an alkali metal is inserted between lattices such as AlSb, Mg₂Si or NiSi₂ having a cubic system. As the material capable of forming an alloy with alkali metal ions, there are metals such as aluminum (Al), lead (Pb), tin (Sn), bismuth (Bi) and silicon (Si), and alloys containing them. A lithium nitrogen compound represented by the general formula Li₃₋ₓMₓN, where M is a transition metal, a titanium spinel compound (Li₄TiO₁₂), lithium vanadium oxide or the like can also be used. The negative electrode active material may be used singly or in any combination of two or more.

Hereinafter, the present invention will be described in detail below by way of examples, but it is to be understood that the present invention is not limited thereto.

### EXAMPLE 1 to 8

(i) Production of Positive Electrode

A mixture obtained by mixing Li₂CO₃, Co₃O₄ and MgCO₃ at a molar ratio of Li:Co:Mg of 1:0.97:0.03 was baked at 900° C. for 10 hours to give a lithium containing transition metal oxide, namely, LiMg_{0.03}Co_{0.97}O_{2-δ} (0≦δ≦1).

To 100 parts by weight of powders of LiMg_{0.03}Co_{0.97}O_{2-δ} serving as a positive electrode active material were added 3 parts by weight of acetylene black serving as a conductive material, 7 parts by weight of an aqueous dispersion containing 40 wt % styrene-butadiene copolymer (BM-400B (trade name) available from Zeon Corporation, Japan) serving as a binder and an appropriate amount of an aqueous solution of carboxymethyl cellulose, which were then mixed to give a positive electrode material mixture paste.

The obtained positive electrode material mixture paste was applied onto both surfaces of a positive electrode current collector made of a 30 μm thick aluminum foil, which was then dried and rolled to give a positive electrode having a thickness of 0.18 mm. A positive electrode lead made of aluminum was welded to the positive electrode current collector.

(ii) Production of Negative Electrode

To 100 parts by weight of powders of artificial graphite serving as a negative electrode active material were added 5 parts by weight of styrene-butadiene copolymer serving as a binder and an appropriate amount of an aqueous solution of carboxymethyl cellulose, which were then mixed to give a negative electrode material mixture paste.

The obtained negative electrode material mixture paste was applied onto both surfaces of a negative electrode current collector made of a 20 μm thick copper foil, which was then dried and rolled to give a negative electrode having a thickness of 0.19 mm. A negative electrode lead made of nickel was welded to the negative electrode current collector.

(iii) Preparation of Non-Aqueous Electrolyte

A non-aqueous solvent was prepared by mixing ethylene carbonate, ethyl methyl carbonate and diethyl carbonate at a volume ratio of 1:2:1. In the obtained non-aqueous solvent was dissolved lithium hexafluorophosphate (LiPF₆) serving as a solute at a concentration of 1.2 mol/L, to which a bromine compound shown in Table 1 (decabromodiphenyl) was added at a concentration shown in Table 1. Thereby, a non-aqueous electrolyte was obtained.

The amount of decabromodiphenyl contained in the non-aqueous electrolyte was varied in the range of 0.008 to 1.572 wt %. In other words, the concentration of bromine atoms contained in the non-aqueous electrolyte was varied in the range of 0.001 to 0.2 mol/L.

(iv) Assembly of Battery

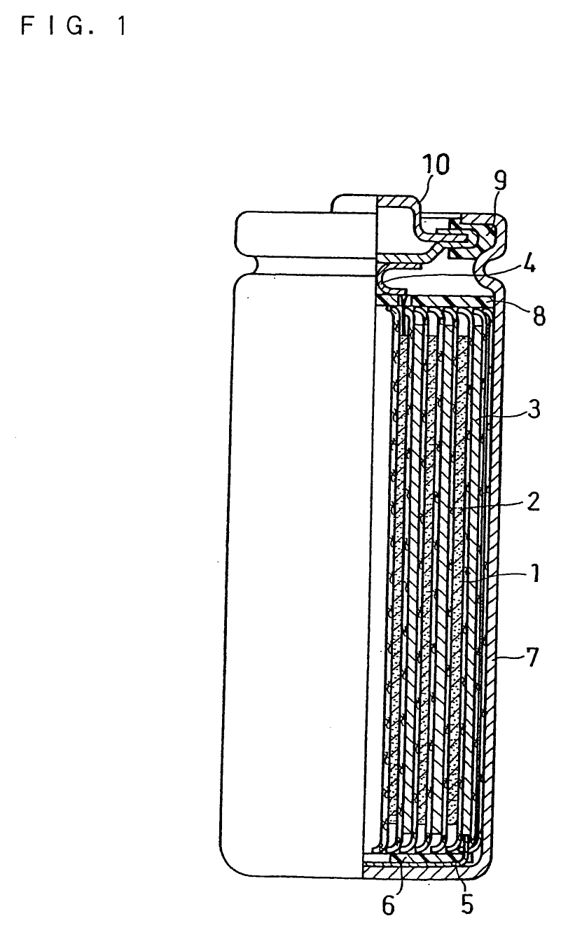

A cylindrical lithium ion secondary battery having a diameter of 18 mm, a height of 65 mm, a nominal voltage of 3.6 V and a nominal capacity of 2400 mAh as shown in FIG. 1 was produced.

A positive electrode 2 and a negative electrode 3 were spirally wound with a separator 1 made of a 25 μm thick polyethylene microporous membrane interposed therebetween to form a columnar electrode group. The electrode group having an upper insulating ring 8 and a lower insulating ring 6 for preventing a short-circuit arranged thereon was housed in a battery can (case) 7 also serving as the negative electrode terminal. The outer surface of the electrode group was wrapped by the separator 1. An end of a positive electrode lead 4 was welded to the underside of a battery lid 10 also serving as the positive electrode terminal. An end of a negative electrode lead 5 was welded to the inner bottom face of the battery can 7. The non-aqueous electrolyte was injected into the battery can 7 to impregnate the electrode group with the non-aqueous electrolyte. The opening of the battery can 7 was sealed by the battery lid 10 with the edge of the opening crimping onto the periphery of the battery lid with an insulating packing 9 therebetween.

(v) Activation of Battery

The assembled battery was alternately charged and discharged at an ambient temperature of 25° C. under the following conditions. The cycle was repeated three times.

Constant current charge: a current of 480 mA (equal to 0.2 C), an end-of-charge voltage of 4.1 V.

Constant current discharge: a current of 480 mA (equal to 0.2 C), an end-of-discharge voltage of 3.0 V.

Subsequently, the battery was subjected to the fourth charging under the above conditions. The battery in a charged state was allowed to stand at 60° C. for two days. Thereby, a finished battery was obtained.

### COMPARATIVE EXAMPLE 1

A battery was produced in the same manner as in EXAMPLE 1 except that decabromodiphenyl was not added to the non-aqueous electrolyte.

### COMPARATIVE EXAMPLE 2

To 100 parts by weight of powders of LiMg_{0.03}Co_{0.97}O_{2-δ} serving as a positive electrode active material were added 3 parts by weight of acetylene black serving as a conductive material, 7 parts by weight of an aqueous dispersion containing 40 wt % styrene-butadiene copolymer (BM-400B (trade name) available from Zeon Corporation, Japan) serving as a binder, an appropriate amount of an aqueous solution of carboxymethyl cellulose (CMC) and decabromodiphenyl, which were then mixed to give a positive electrode material mixture paste.

A battery was produced in the same manner as in EXAMPLE 1 except that the obtained positive electrode material mixture paste containing decabromodiphenyl was used and that decabromodiphenyl was not added to the non-aqueous electrolyte.

The content of decabromodiphenyl in the positive electrode material mixture (i.e. the percentage by weight of decabromodiphenyl to the total amount of the positive electrode active material, conductive material, binder, CMC and decabromodiphenyl) was 0.15 wt %.

### COMPARATIVE EXAMPLE 3

To 100 parts by weight of powders of artificial graphite serving as a negative electrode active material were added 5 parts by weight of styrene-butadiene copolymer serving as a binder, an appropriate amount of an aqueous solution of carboxymethyl cellulose (CMC) and decabromodiphenyl, which were then mixed to give a negative electrode material mixture paste.

A battery was produced in the same manner as in EXAMPLE 1 except that the obtained negative electrode material mixture paste containing decabromodiphenyl was used and that decabromodiphenyl was not added to the non-aqueous electrolyte.

The content of decabromodiphenyl in the negative electrode material mixture (i.e. the percentage by weight of decabromodiphenyl to the total amount of the negative electrode active material, binder, CMC and decabromodiphenyl) was 0.15 wt %.

### COMPARTIVE EXAMPLE 4

A battery was produced in the same manner as in EXAMPLE 1 except that, instead of decabromodiphenyl, hexabromobenzene was added to the non-aqueous electrolyte as a bromine compound.

The amount of hexabromobenzene contained in the non-aqueous electrolyte was 2 wt %. In other words, the concentration of bromine atoms contained in the non-aqueous electrolyte was 0.26 mol/L.

### COMPARTIVE EXAMPLE 5

A battery was produced in the same manner as in EXAMPLE 1 except that, instead of decabromodiphenyl, hexabromocyclododecan was added to the non-aqueous electrolyte as a bromine compound.

The amount of hexabromocyclododecan contained in the non-aqueous electrolyte was 2 wt %. In other words, the concentration of bromine atoms contained in the non-aqueous electrolyte was 0.22 mol/L.

TABLE 1

| | | Bromine | | | |
|---|---|---|---|---|---|
| | | compound- | C_{Br} | | C_{W2} |
| | Bromine compound | containing part | (mol/L) | C_{W1} (wt %) | (wt %) |
| Ex. 1 | decabromodiphenyl | Non-aqueous | 0.001 | 0.008 | — |
| | | electrolyte | | | |
| Ex. 2 | decabromodiphenyl | Non-aqueous | 0.003 | 0.024 | — |
| | | electrolyte | | | |
| Ex. 3 | decabromodiphenyl | Non-aqueous | 0.005 | 0.039 | — |
| | | electrolyte | | | |
| Ex. 4 | decabromodiphenyl | Non-aqueous | 0.01 | 0.079 | — |
| | | electrolyte | | | |
| Ex. 5 | decabromodiphenyl | Non-aqueous | 0.03 | 0.236 | — |
| | | electrolyte | | | |
| Ex. 6 | decabromodiphenyl | Non-aqueous | 0.05 | 0.393 | — |
| | | electrolyte | | | |
| Ex. 7 | decabromodiphenyl | Non-aqueous | 0.1 | 0.786 | — |
| | | electrolyte | | | |
| Ex. 8 | decabromodiphenyl | Non-aqueous | 0.2 | 1.572 | — |
| | | electrolyte | | | |
| Comp. Ex. 1 | None | None | 0 | 0 | — |
| Comp. Ex. 2 | decabromodiphenyl | Positive | — | — | 0.15 |
| | | electrode | | | |
| Comp. Ex. 3 | decabromodiphenyl | Negative | — | — | 0.15 |
| | | electrode | | | |
| Comp. Ex. 4 | hexabromobenzene | Non-aqueous | 0.26 | 2 | — |
| | | electrolyte | | | |
| Comp. Ex. 5 | hexabromocyclododecan | Non-aqueous | 0.22 | 2 | — |
| | | electrolyte | | | |

C_{Br}: the amount of bromine atoms relative to the amount of non-aqueous electrolyte (the concentration of bromine atoms contained in non-aqueous electrolyte).
C_{W1}: the amount of bromine compound contained in non-aqueous electrolyte.
C_{W2}: the amount of bromine compound contained in electrode material mixture.

[Evaluation]

The batteries of EXAMPLEs 1 to 8 and COMPARATIVE EXAMPLEs 1 to 5, ten of each, were measured for initial discharge capacity. After checking the initial discharge capacity, the batteries were subjected to a high rate discharge test and a high temperature charge storage test. In the high rate discharge test, ten of each of the batteries were used. The high temperature charge storage test was performed after the high rate discharge test. Out of ten batteries after high temperature storage, five batteries were used for measuring the amount of generated gas after the storage, and the remaining five were used for measuring discharge capacity to yield recovery rate after the storage. In order to examine the safety of the batteries, another batteries, ten of each, were also subjected to an overcharge test and a cycle test. The values shown in Tables are all the average of either ten batteries or five batteries.

(Initial Discharge Capacity)

Before the tests, the discharge capacity of each battery was measured.

Ten of each battery charged for activation were first discharged at a constant current of 1200 mA (equal to 0.5 C) to an end-of-discharge voltage of 2.5 V at an ambient temperature of 25° C.

They were then repeatedly (three times) charged and discharged under the following conditions at an ambient temperature of 25° C. The discharge capacity at the third cycle was measured. Then, the average value of ten batteries was calculated.

Constant current charge: a current of 1680 mA (equal to 0.7 C), an end-of-charge voltage of 4.2 V.

Constant voltage charge: a voltage of 4.2 V, a charge time of 2.5 hours.

Constant current discharge: a current of 1200 mA (equal to 0.5 C), an end-of-discharge voltage of 2.5 V.

(High Rate Discharge Test (High Rate Discharge Characteristics (2 C/0.5 C)))

After checking the initial discharge capacity, the batteries were charged and discharged under the following conditions at an ambient temperature of 25° C. to determine a discharge capacity at 2 C.

Constant current charge: a current of 1680 mA (equal to 0.7 C), an end-of-charge voltage of 4.2 V.

Constant voltage charge: a voltage of 4.2 V, a charge time of 2.5 hours.

Constant current discharge: a current of 4800 mA (equal to 2 C), an end-of-discharge voltage of 2.5 V.

Further, they were charged and discharged under the following conditions at an ambient temperature of 25° C. to determine a discharge capacity at 0.5 C.

Constant current charge: a current of 1680 mA (equal to 0.7 C), an end-of-charge voltage of 4.2 V.

Constant voltage charge: a voltage of 4.2 V, a charge time of 2.5 hours.

Constant current discharge: a current of 1200 mA (equal to 0.5 C), an end-of-discharge voltage of 2.5 V.

The rate of discharge capacity at 2 C to discharge capacity at 0.5 C was calculated in percentage. The resulting value was referred to as high rate discharge characteristics (2 C/0.5 C).

(High Temperature Charge Storage Test)

(i) Recovery Rate After Storage

After the high rate discharge test, the batteries were charged under the following conditions at an ambient temperature of 25° C.

Constant current charge: a current of 1680 mA (equal to 0.7 C), an end-of-charge voltage of 4.25 V.

Constant voltage charge: a voltage of 4.25 V, a charge time of 2.5 hours.

Subsequently, the batteries in a charged state were stored at an ambient temperature of 60° C. for 20 days. After storage, the batteries were discharged under the following conditions at an ambient temperature of 25° C.

Constant current discharge: a current of 1200 mA (equal to 0.5 C), an end-of-discharge voltage of 2.5 V.

They were then repeatedly (three times) charged and discharged under the following conditions at an ambient temperature of 25° C. The discharge capacity at the third cycle was measured as a discharge capacity after storage.

Constant current charge: a current of 1680 mA (equal to 0.7 C), an end-of-charge voltage of 4.2 V.

Constant voltage charge: a voltage of 4.2 V, a charge time of 2.5 hours.

Constant current discharge: a current of 1200 mA (equal to 0.5 C), an end-of-discharge voltage of 2.5 V.

The rate of discharge capacity after storage to initial discharge capacity was calculated in percentage. The resulting value was referred to as recovery rate.

(ii) Gas Amount After Storage

After the storage, the battery and a drawing pin were placed in a bag made of Teflon (registered trademark). The bag was filled with a known amount of argon gas, which was then sealed. Using the drawing pin in the bag, a hole was made in the sealing plate of the battery in the bag. Gas from the battery was collected in the bag. The amount of the collected gas was measured by gas chromatography.

(Over Charge Test)

After checking the initial discharge capacity, another batteries, ten of each, were charged under the following conditions at an ambient temperature of 25° C.

Constant current charge: a current of 1680 mA (equal to 0.7 C), an end-of-charge voltage of 4.2 V.

Constant voltage charge: a voltage of 4.2 V, a charge time of 2.5 hours.

The batteries in a charged state were continuously charged at a current of 2400 mA (equal to 1 C), after which the batteries were checked to see if the battery temperature was above 120° C. The number of batteries having a temperature exceeding 120° C was counted.

(Cycle Test)

After checking the initial discharge capacity, another batteries, ten of each, were repeatedly (three times) charged and discharged under the following conditions at an ambient temperature of 25° C. The discharge capacity at the third cycle was measured.

Constant current charge: a current of 1680 mA (equal to 0.7 C), an end-of-charge voltage of 4.2 V.

Constant voltage charge: a voltage of 4.2 V, a charge time of 2.5 hours.

Constant current discharge: a current of 1200 mA (equal to 0.5 C), an end-of-discharge voltage of 2.5 V.

The batteries were then repeatedly (496 cycles) charged and discharged under the following conditions at an ambient temperature of 25° C.

Constant current charge: a current of 2400 mA (equal to 1 C), an end-of-charge voltage of 4.2 V.

Constant voltage charge: a voltage of 4.2 V, a charge time of 2.5 hours.

Constant current discharge: a current of 2400 mA (equal to 1 C), an end-of-discharge voltage of 2.5 V.

Then, the 500th charging/discharging (the 500th cycle) was performed under the following conditions.

Constant current charge: a current of 1680 mA (equal to 0.7 C), an end-of-charge voltage of 4.2 V.

Constant voltage charge: a voltage of 4.2 V, a charge time of 2.5 hours.

Constant current discharge: a current of 1200 mA (equal to 0.5 C), an end-of-discharge voltage of 2.5 V.

The rate of discharge capacity at the 500th cycle to discharge capacity at the third cycle was calculated in percentage. The resulting value was referred to as capacity retention rate.

Table 2 shows the results of the high rate discharge test, high temperature charge storage test, overcharge test and cycle test.

TABLE 2

| | | | | | | Capacity |
|---|---|---|---|---|---|---|
| | High rate | | Recovery | Gas | | retention |
| | discharge | Initial | rate | amount | | rate |
| | characteristics | discharge | after | after | Number of | after 500 |
| | 2 C/0.5 C | capacity | storage | storage | batteries | cycles |
| | (%) | (mAh) | (%) | (ml) | above 120° C. | (%) |
| Ex. 1 | 95.3 | 2404 | 94.0 | 9.9 | 0/10 | 83.4 |
| Ex. 2 | 95.2 | 2396 | 95.2 | 8.5 | 0/10 | 84.2 |
| Ex. 3 | 95.2 | 2397 | 95.8 | 7.4 | 0/10 | 84.4 |
| Ex. 4 | 95.1 | 2395 | 95.3 | 6.8 | 0/10 | 84.6 |
| Ex. 5 | 94.8 | 2404 | 94.5 | 6.3 | 0/10 | 84.3 |
| Ex. 6 | 94.5 | 2403 | 94.2 | 6.2 | 0/10 | 83.7 |
| Ex. 7 | 94.2 | 2403 | 93.5 | 6.0 | 0/10 | 83.5 |
| Ex. 8 | 93.8 | 2396 | 92.5 | 5.9 | 0/10 | 83.1 |
| Comp. Ex. 1 | 95.2 | 2403 | 92.3 | 15.0 | 3/10 | 82.8 |
| Comp. Ex. 2 | 85.4 | 2405 | 89.1 | 13.3 | 0/10 | 69.8 |
| Comp. Ex. 3 | 86.2 | 2403 | 89.2 | 12.8 | 0/10 | 73.5 |
| Comp. Ex. 4 | 94.8 | 2402 | 92.0 | 14.6 | 0/10 | 82.5 |
| Comp. Ex. 5 | 94.5 | 2399 | 91.6 | 14.8 | 0/10 | 82.1 |

As shown in Table 2, the amount of gas generated during storage for the batteries of EXAMPLEs 1 to 8 was smaller than that for the batteries of COMPARATIVE EXAMPLEs 1 to 5. Among the batteries of EXAMPLEs 1 to 8, particularly the batteries in which the concentration of bromine atoms contained in the non-aqueous electrolyte was not less than 0.003 mol/L exhibited a small amount of generated gas. As for the recovery rate after storage, the rate increased with increasing amount of the bromine compound. However, when the concentration of bromine atoms contained in the non-aqueous electrolyte was not less than 0.01 mol/L, the recovery rate decreased. This indicates that the concentration of bromine atoms contained in the non-aqueous electrolyte is preferably 0.003 to 0.1 mol/L from the viewpoint of the balance between the amount of generated gas and the recovery rate, more preferably 0.003 to 0.05 mol/L.

As for the overcharge test, in COMPARATIVE EXAMPLE 1, three batteries out of ten had a temperature exceeding 120° C. whereas, in EXAMPLEs 1 to 8, there were no batteries having a temperature exceeding 120° C. This indicates that the addition of the bromine compound to the non-aqueous electrolyte can increase the safety of the battery.

The batteries of EXAMPLEs 1 to 8 exhibited excellent high rate discharge characteristics as well as excellent capacity retention rate after 500 cycles. This is presumably due to the effect of the film containing a product generated from the decomposition of the bromine compound that is produced on the positive and negative electrodes.

The batteries of COMPARATIVE EXAMPLEs 2 and 3 in which decabromodiphenyl was added to the positive or negative electrode exhibited improved safety compared to the battery of COMPARATIVE EXAMPLE 1, but the effect of suppressing gas generation after storage was not observed. Moreover, they exhibited lower values than the battery of COMPARATIVE EXAMPLE 1 in terms of high rate discharge characteristics and capacity retention rate after 500 cycles. From this, it is clear that when a bromine compound having an aromatic ring is added to an electrode like the batteries of COMPARATIVE EXAMPLEs 2 and 3, although the effect of improving safety is obtained, it negatively affects the high rate discharge characteristics and cycle characteristics. Presumably, this is because an insulating substance such as bromine compound having an aromatic ring remains in the electrode.

Hexabromobenzene used in COMPARTIVE EXAMPLE 4 and hexabromocyclododecan used in COMPARATIVE EXAMPLE 5 have a relatively low molecular weight, and they exist in the form of a liquid at room temperature. Accordingly, they are easily mixed with a non-aqueous electrolyte. However, the batteries of COMPARATIVE EXAMPLEs 4 and 5 did not have the effect of suppressing gas generation after storage, and their capacity recovery rate after storage was also low although they exhibited excellent safety and excellent high rate discharge characteristics. This is presumably because the film produced on the positive and negative electrodes was not uniform. Since hexabromobenzene used in COMPARTIVE EXAMPLE 4 has a relatively low molecular weight, it is surmised that, even when it is decomposed, a desired film is not produced. Likewise, since hexabromocyclododecan used in COMPARATIVE EXAMPLE 5 does not have an aromatic ring, it is surmised that the effect of suppressing gas generation does not appear.

### EXAMPLES 9 to 132

Batteries of EXAMPLEs 9 to 132 were produced in the same manner as in EXAMPLE 1 except that the bromine compounds listed in Tables 3A to 3F were added to the non-aqueous electrolyte at a concentration listed in Tables 3A to 3F. The produced batteries were also subjected to the same evaluation tests as above.

Hereinafter, some of the bromine compounds shown in Tables 3A to 3F will be detailed.

<1> Tetrabromobisphenol A-carbonate oligomer used in EXAMPLEs 24 to 26 (Table 3A) is a bromine compound represented by the formula (8), where X₅₁ to X₅₆ are all hydrogen atoms, and n is 5.

<2> Tetrabromobisphenol A-base epoxy resin used in EXAMPLEs 27 to 29 (Table 3A) is a bromine compound represented by the formula (9), where X₅₇ to X₆₀ are all bromine atoms, and n is 1.

<3> Polydibromophenylene oxide used in EXAMPLEs 30 to 32 (Table 3B) is a bromine compound represented by the formula (10), where X₆₁ to X₆₅ are all bromine atoms, and n is 20.

<4> Poly(pentabromobenzyl)acrylate used in EXAMPLEs 33 to 35 (Table 3B) is a bromine compound represented by the formula (11), where X₆₆ to X₇₀ are all bromine atoms, and n is 140.

<5> Brominated polystyrene used in EXAMPLEs 36 to 38 (Table 3B) is a bromine compound represented by the formula (12), where X₇₁ to X₇₅ are all bromine atoms, and n is 440.

<6> Polybrominated acetonaphthylene used in EXAMPLEs 39 to 41 (Table 3B) is a bromine compound represented by the formula (13), where x+y+z=6, and n is 2.

<7> Tetrabromobisphenol A-carbonate oligomer 1 used in EXAMPLE 92 (Table 3D) is a bromine compound represented by the formula (8), where X₅₁ to X₅₆ are all bromine atoms, and n is 5.

<8> Tetrabromobisphenol A-carbonate oligomer 2 used in EXAMPLE 93 (Table 3D) is a bromine compound represented by the formula (8), where X₅₁ to X₅₆ are all hydrogen atoms, and n is 2.

<9> Tetrabromobisphenol A-carbonate oligomer 3 used in EXAMPLE 94 (Table 3D) is a bromine compound represented by the formula (8), where X₅₁ to X₅₆ are all hydrogen atoms, and n is 7.

<10> Tetrabromobisphenol A-carbonate oligomer 4 used in EXAMPLE 95 (Table 3D) is a bromine compound represented by the formula (8), where X₅₁ to X₅₆ are all hydrogen atoms, and n is 10.

<11> Tetrabromobisphenol A-base epoxy resin 1 used in EXAMPLE 96 (Table 3D) is a bromine compound represented by the formula (9), where X₅₇ to X₆₀ are all bromine atoms, and n is 2.

<12> Tetrabromobisphenol A-base epoxy resin 2 used in EXAMPLE 97 (Table 3D) is a bromine compound represented by the formula (9), where X₅₇ to X₆₀ are all bromine atoms, and n is 5.

<13> Tetrabromobisphenol A-base epoxy resin 3 used in EXAMPLE 98 (Table 3D) is a bromine compound represented by the formula (9), where X₅₇ to X₆₀ are all bromine atoms, and n is 65.

<14> Tetrabromobisphenol A-base epoxy resin 4 used in EXAMPLE 99 (Table 3E) is a bromine compound represented by the formula (9), where X₅₇ to X₆₀ are all bromine atoms, and n is 80.

<15> Tetrabromobisphenol A-base epoxy resin 5 used in EXAMPLE 100 (Table 3E) is a bromine compound represented by the formula (9), where X₅₇ to X₆₀ are all bromine atoms, and n is 100.

<16> Tetrabromobisphenol A-base epoxy resin 6 used in EXAMPLE 101 (Table 3E) is a bromine compound represented by the formula (9), where X₅₇ to X₆₀ are all hydrogen atoms, and n is 1.

<17> Tetrabromobisphenol A-base epoxy resin 7 used in EXAMPLE 102 (Table 3E) is a bromine compound represented by the formula (9), where X₅₇ to X₆₀ are all hydrogen atoms, and n is 5.

<18> Polydibromophenylene oxide 1 used in EXAMPLE 103 (Table 3E) is a bromine compound represented by the formula (10), where X₆₁ to X₆₅ are all bromine atoms, and n is 10.

<19> Polydibromophenylene oxide 2 used in EXAMPLE 104 (Table 3E) is a bromine compound represented by the formula (10), where X₆₁ to X₆₅ are all bromine atoms, and n is 30.

<20> Polydibromophenylene oxide 3 used in EXAMPLE 105 (Table 3E) is a bromine compound represented by the formula (10), where X₆₁ to X₆₅ are all hydrogen atoms, and n is 10.

<21> Polydibromophenylene oxide 4 used in EXAMPLE 106 (Table 3E) is a bromine compound represented by the formula (10), where X₆₁ to X₆₅ are all hydrogen atoms, and n is 20.

<22> Poly(pentabromobenzyl)acrylate 1 used in EXAMPLE 107 (Table 3E) is a bromine compound represented by the formula (11), where X₆₆ to X₇₀ are all bromine atoms, and n is 100.

<23> Poly(pentabromobenzyl)acrylate 2 used in EXAMPLE 108 (Table 3E) is a bromine compound represented by the formula (11), where X₆₆ to X₇₀ are all bromine atoms, and n is 200.

<24> Poly(pentabromobenzyl)acrylate 3 used in EXAMPLE 109 (Table 3E) is a bromine compound represented by the formula (11), where X₆₆ to X₇₀ are all bromine atoms, and n is 140.

<25> Poly(2,4,6-tribromobenzyl)acrylate used in EXAMPLE 110 (Table 3E) is a bromine compound represented by the formula (11), where X₆₆, X₆₈ and X₇₀ are bromine atoms, X₆₇ and X₆₉ are hydrogen atoms, and n is 100.

<26> Poly(3,5-dibromobenzyl)acrylate used in EXAMPLE 111 (Table 3E) is a bromine compound represented by the formula (11), where X₆₇ and X₆₉ are bromine atoms, X₆₆, X₆₈ and X₇₀ are hydrogen atoms, and n is 100.

<27> Polypentabromostyrene 1 used in EXAMPLE 112 (Table 3E) is a bromine compound represented by the formula (12), where n is 200.

<28> Polypentabromostyrene 2 used in EXAMPLE 113 (Table 3E) is a bromine compound represented by the formula (12), where n is 600.

<29> Poly(2,4,6-tribromo)styrene used in EXAMPLE 114 (Table 3E) is a bromine compound represented by the formula (12), where n is 200.

<30> Poly(3,5-dibromo)styrene used in EXAMPLE 115 (Table 3E) is a bromine compound represented by the formula (12), where n is 200.

<31> Polybrominated acetonaphthylene 1 used in EXAMPLE 116 (Table 3E) is a bromine compound represented by the formula (13), where x+y+z=6, and n is 3.

<32> Polybrominated acetonaphthylene 2 used in EXAMPLE 117 (Table 3E) is a bromine compound represented by the formula (13), where x+y+z=6, and n is 5.

<33> Polybrominated acetonaphthylene 3 used in EXAMPLE 118 (Table 3E) is a bromine compound represented by the formula (13), where x+y+z=4, and n is 2.

<34> Polybrominated acetonaphthylene 4 used in EXAMPLE 119 (Table 3E) is a bromine compound represented by the formula (13), where x+y+z=2, and n is 2.

Tables 4A to 4F show the results of the high rate discharge characteristics, initial discharge capacity, recovery rate after storage and gas amount after storage (i.e. the amount of gas generated during storage).

TABLE 3A

| | | C_{Br} |
|---|---|---|
| | Bromine compound | (mol/L) |
| Ex. 9 | decabromodiphenyl ether | 0.005 |
| Ex. 10 | decabromodiphenyl ether | 0.01 |
| Ex. 11 | decabromodiphenyl ether | 0.03 |
| Ex. 12 | hexabromodiphenoxy ethane | 0.005 |
| Ex. 13 | hexabromodiphenoxy ethane | 0.01 |
| Ex. 14 | hexabromodiphenoxy ethane | 0.03 |
| Ex. 15 | tetrabromophthalic anhydride | 0.005 |
| Ex. 16 | tetrabromophthalic anhydride | 0.01 |
| Ex. 17 | tetrabromophthalic anhydride | 0.03 |
| Ex. 18 | ethylenebistetrabromophthalimide | 0.005 |
| Ex. 19 | ethylenebistetrabromophthalimide | 0.01 |
| Ex. 20 | ethylenebistetrabromophthalimide | 0.03 |
| Ex. 21 | tetrabromobisphenol A-bis-(2,3-dibromopropyl ether) | 0.005 |
| Ex. 22 | tetrabromobisphenol A-bis-(2,3-dibromopropyl ether) | 0.01 |
| Ex. 23 | tetrabromobisphenol A-bis-(2,3-dibromopropyl ether) | 0.03 |
| Ex. 24 | tetrabromobisphenol A-carbonate oligomer | 0.005 |
| Ex. 25 | tetrabromobisphenol A-carbonate oligomer | 0.01 |
| Ex. 26 | tetrabromobisphenol A-carbonate oligomer | 0.03 |
| Ex. 27 | tetrabromobisphenol A-base epoxy resin | 0.005 |
| Ex. 28 | tetrabromobisphenol A-base epoxy resin | 0.01 |
| Ex. 29 | tetrabromobisphenol A-base epoxy resin | 0.03 |

C_{Br}: the amount of bromine atoms relative to the amount of non-aqueous electrolyte (the concentration of bromine atoms contained in non-aqueous electrolyte).

TABLE 3B

| | | C_{Br} |
|---|---|---|
| | Bromine compound | (mol/L) |
| Ex. 30 | polydibromophenylene oxide | 0.005 |
| Ex. 31 | polydibromophenylene oxide | 0.01 |
| Ex. 32 | polydibromophenylene oxide | 0.03 |
| Ex. 33 | poly(pentabromobenzyl)acrylate | 0.005 |
| Ex. 34 | poly(pentabromobenzyl)acrylate | 0.01 |
| Ex. 35 | poly(pentabromobenzyl)acrylate | 0.03 |
| Ex. 36 | brominated polystyrene | 0.005 |
| Ex. 37 | brominated polystyrene | 0.01 |
| Ex. 38 | brominated polystyrene | 0.03 |
| Ex. 39 | polybrominated acetonaphthylene | 0.005 |
| Ex. 40 | polybrominated acetonaphthylene | 0.01 |
| Ex. 41 | polybrominated acetonaphthylene | 0.03 |
| Ex. 42 | tribromophenyl maleimide | 0.005 |
| Ex. 43 | tribromophenyl maleimide | 0.01 |
| Ex. 44 | tribromophenyl maleimide | 0.03 |
| Ex. 45 | pentabromobenzyl acrylate | 0.005 |
| Ex. 46 | pentabromobenzyl acrylate | 0.01 |
| Ex. 47 | pentabromobenzyl acrylate | 0.03 |
| Ex. 48 | tribromostyrene | 0.005 |
| Ex. 49 | tribromostyrene | 0.01 |
| Ex. 50 | tribromostyrene | 0.03 |
| Ex. 51 | tris(pentabromobenzyl)isocyanurate | 0.005 |
| Ex. 52 | tris(pentabromobenzyl)isocyanurate | 0.01 |
| Ex. 53 | tris(pentabromobenzyl)isocyanurate | 0.03 |
| Ex. 54 | tris(tribromobenzyl)isocyanurate | 0.005 |
| Ex. 55 | tris(tribromobenzyl)isocyanurate | 0.01 |
| Ex. 56 | tris(tribromobenzyl)isocyanurate | 0.03 |

C_{Br}: the amount of bromine atoms relative to the amount of non-aqueous electrolyte (the concentration of bromine atoms contained in non-aqueous electrolyte).

TABLE 3C

| | | C_{Br} |
|---|---|---|
| | Bromine compound | (mol/L) |
| Ex. 57 | octabromodiphenyl | 0.01 |
| Ex. 58 | hexabromodiphenyl | 0.01 |
| Ex. 59 | tetrabromodiphenyl | 0.01 |
| Ex. 60 | dibromodiphenyl | 0.01 |
| Ex. 61 | monobromodiphenyl | 0.01 |
| Ex. 62 | octabromodiphenyl ether | 0.01 |
| Ex. 63 | hexabromodiphenyl ether | 0.01 |
| Ex. 64 | tetrabromodiphenyl ether | 0.01 |
| Ex. 65 | dibromodiphenyl ether | 0.01 |
| Ex. 66 | monobromodiphenyl ether | 0.01 |
| Ex. 67 | decabromophenoxy ethane | 0.01 |
| Ex. 68 | octabromophenoxy ethane | 0.01 |
| Ex. 69 | tetrabromophenoxy ethane | 0.01 |
| Ex. 70 | dibromophenoxy ethane | 0.01 |
| Ex. 71 | hexabromodiphenoxy methane | 0.01 |
| Ex. 72 | hexabromodiphenoxy propane | 0.01 |
| Ex. 73 | hexabromodiphenoxy butane | 0.01 |
| Ex. 74 | tribromophthalic anhydride | 0.01 |
| Ex. 75 | dibromophthalic anhydride | 0.01 |
| Ex. 76 | monobromophthalic anhydride | 0.01 |

C_{Br}: the amount of bromine atoms relative to the amount of non-aqueous electrolyte (the concentration of bromine atoms contained in non-aqueous electrolyte).

TABLE 3D

| | | C_{Br} |
|---|---|---|
| | Bromine compound | (mol/L) |
| Ex. 77 | 2-ethoxyethyl-2-methoxyethyl-tetrabromophthalate | 0.01 |
| | ester | |
| Ex. 78 | 2-ethoxyethyl-2-methoxyethyl-dibromophthalate ester | 0.01 |
| EX. 79 | 2-(2-hydroxyethoxy)ethyl-2-hydroxypropyl- | 0.01 |
| | tetrabromophthalate ester | |
| Ex. 80 | 2-(2-hydroxyethoxy)ethyl-2-hydroxypropyl- | 0.01 |
| | monobromophthalate ester | |
| Ex. 81 | bistetrabromophthalimide | 0.01 |
| Ex. 82 | methylenebistetrabromophthalimide | 0.01 |
| Ex. 83 | propylenebistetrabromophthalimide | 0.01 |
| Ex. 84 | butylene bistetrabromophthalimide | 0.01 |
| Ex. 85 | ethylene bistribromophthalimide | 0.01 |
| Ex. 86 | ethylene bisdibromophthalimide | 0.01 |
| Ex. 87 | ethylene bismonobromophthalimide | 0.01 |
| Ex. 88 | tetrabromobisphenol A-bis-(2-hydroxyethyl ether) | 0.01 |
| Ex. 89 | tetrabromobisphenol A-bis-(allyl ether) | 0.01 |
| Ex. 90 | dibromobisphenol A-bis-(2,3-dibromopropyl ether) | 0.01 |
| Ex. 91 | dibromobisphenol A-bis-(2-hydroxyethyl ether) | 0.01 |
| Ex. 92 | tetrabromobisphenol A-carbonate oligomer 1 | 0.01 |
| Ex. 93 | tetrabromobisphenol A-carbonate oligomer 2 | 0.01 |
| Ex. 94 | tetrabromobisphenol A-carbonate oligomer 3 | 0.01 |
| Ex. 95 | tetrabromobisphenol A-carbonate oligomer 4 | 0.01 |
| Ex. 96 | tetrabromobisphenol A-base epoxy resin 1 | 0.01 |
| Ex. 97 | tetrabromobisphenol A-base epoxy resin 2 | 0.01 |
| Ex. 98 | tetrabromobisphenol A-base epoxy resin 3 | 0.01 |

C_{Br}: the amount of bromine atoms relative to the amount of non-aqueous electrolyte (the concentration of bromine atoms contained in non-aqueous electrolyte).

TABLE 3E

| | | C_{Br} |
|---|---|---|
| | Bromine compound | (mol/L) |
| Ex. 99 | tetrabromobisphenol A-base epoxy resin 4 | 0.01 |
| Ex. 100 | tetrabromobisphenol A-base epoxy resin 5 | 0.01 |
| Ex. 101 | tetrabromobisphenol A-base epoxy resin 6 | 0.01 |
| Ex. 102 | tetrabromobisphenol A-base epoxy resin 7 | 0.01 |
| Ex. 103 | polydibromophenylene oxide 1 | 0.01 |
| Ex. 104 | polydibromophenylene oxide 2 | 0.01 |
| Ex. 105 | polydibromophenylene oxide 3 | 0.01 |
| Ex. 106 | polydibromophenylene oxide 4 | 0.01 |
| Ex. 107 | poly(pentabromobenzyl)acrylate 1 | 0.01 |
| Ex. 108 | poly(pentabromobenzyl)acrylate 2 | 0.01 |
| Ex. 109 | poly(pentabromobenzyl)acrylate 3 | 0.01 |
| Ex. 110 | poly(2,4,6-tribromobenzyl)acrylate | 0.01 |
| Ex. 111 | poly(3,5-dibromobenzyl)acrylate | 0.01 |
| Ex. 112 | polypentabromostyrene 1 | 0.01 |
| Ex. 113 | polypentabromostyrene 2 | 0.01 |
| Ex. 114 | poly(2,4,6-tribromo)styrene | 0.01 |
| Ex. 115 | poly(3,5-dibromo)styrene | 0.01 |
| Ex. 116 | polybrominated acetonaphthylene 1 | 0.01 |
| Ex. 117 | polybrominated acetonaphthylene 2 | 0.01 |
| Ex. 118 | polybrominated acetonaphthylene 3 | 0.01 |
| Ex. 119 | polybrominated acetonaphthylene 4 | 0.01 |

C_{Br}: the amount of bromine atoms relative to the amount of non-aqueous electrolyte (the concentration of bromine atoms contained in non-aqueous electrolyte).

TABLE 3F

| | | C_{Br} |
|---|---|---|
| | Bromine compound | (mol/L) |
| Ex. 120 | monobromophenylmaleimide | 0.01 |
| Ex. 121 | dibromophenylmaleimide | 0.01 |
| Ex. 122 | pentabromophenylmaleimide | 0.01 |
| Ex. 123 | monobromobenzylacrylate | 0.01 |
| Ex. 124 | dibromobenzylacrylate | 0.01 |
| Ex. 125 | tribromobenzylacrylate | 0.01 |
| Ex. 126 | monobromostyrene | 0.01 |
| Ex. 127 | dibromostyrene | 0.01 |
| Ex. 128 | pentabromostyrene | 0.01 |
| Ex. 129 | tris(monobromobenzyl)isocyanurate | 0.01 |
| Ex. 130 | tris(dibromobenzyl)isocyanurate | 0.01 |
| Ex. 131 | bis(pentabromobenzyl)mono(tribromobenzyl) | 0.01 |
| | isocyanurate | |
| Ex. 132 | mono(monobromobenzyl)mono(tribromobenzyl) | 0.01 |
| | mono(pentabromobenzyl)isocyanurate | |

C_{Br}: the amount of bromine atoms relative to the amount of non-aqueous electrolyte (the concentration of bromine atoms contained in non-aqueous electrolyte).

TABLE 4A

| | High rate discharge | | |
|---|---|---|---|
| | characteristics | Recovery rate | Gas amount |
| | 2 C/0.5 C | after storage | after storage |
| | (%) | (%) | (ml) |
| Ex. 9 | 95.1 | 95.4 | 6.7 |
| Ex. 10 | 94.8 | 95.2 | 6.3 |
| Ex. 11 | 94.5 | 94.7 | 6.1 |
| Ex. 12 | 94.9 | 95.0 | 7.1 |
| Ex. 13 | 94.7 | 94.8 | 6.8 |
| Ex. 14 | 94.3 | 94.2 | 6.5 |
| Ex. 15 | 95.3 | 95.7 | 6.8 |
| Ex. 16 | 95.0 | 95.5 | 6.4 |
| Ex. 17 | 94.6 | 95.1 | 6.2 |
| Ex. 18 | 95.4 | 95.6 | 6.9 |
| Ex. 19 | 95.1 | 95.4 | 6.5 |
| Ex. 20 | 94.8 | 95.1 | 6.2 |
| Ex. 21 | 95.3 | 95.0 | 7.2 |
| Ex. 22 | 94.9 | 94.7 | 6.8 |
| Ex. 23 | 94.5 | 94.3 | 6.5 |
| Ex. 24 | 95.2 | 94.9 | 6.9 |
| Ex. 25 | 95.0 | 94.7 | 6.6 |
| Ex. 26 | 94.7 | 94.4 | 6.3 |
| Ex. 27 | 94.9 | 95.5 | 6.7 |
| Ex. 28 | 94.8 | 95.2 | 6.3 |
| Ex. 29 | 94.5 | 94.9 | 6.1 |

TABLE 4B

| | High rate discharge | | |
|---|---|---|---|
| | characteristics | Recovery rate | Gas amount |
| | 2 C/0.5 C | after storage | after storage |
| | (%) | (%) | (ml) |
| Ex. 30 | 95.1 | 95.2 | 7.3 |
| Ex. 31 | 94.9 | 95.3 | 6.9 |
| Ex. 32 | 94.4 | 94.6 | 6.6 |
| Ex. 33 | 95.2 | 95.8 | 6.9 |
| Ex. 34 | 94.9 | 95.5 | 6.4 |
| Ex. 35 | 94.6 | 95.3 | 6.2 |
| Ex. 36 | 95.2 | 95.5 | 7.3 |
| Ex. 37 | 94.7 | 95.3 | 6.9 |
| Ex. 38 | 94.3 | 95.0 | 6.5 |
| Ex. 39 | 95.1 | 94.9 | 7.0 |
| Ex. 40 | 94.8 | 94.5 | 6.5 |
| Ex. 41 | 94.4 | 94.1 | 6.2 |
| Ex. 42 | 95.2 | 94.9 | 7.0 |
| Ex. 43 | 94.7 | 94.6 | 6.6 |
| Ex. 44 | 94.2 | 94.1 | 6.3 |
| Ex. 45 | 95.2 | 95.8 | 7.2 |
| Ex. 46 | 94.7 | 95.6 | 6.8 |
| Ex. 47 | 94.3 | 95.3 | 6.3 |
| Ex. 48 | 95.1 | 95.5 | 6.9 |
| Ex. 49 | 94.6 | 95.2 | 6.3 |
| Ex. 50 | 94.3 | 94.8 | 6.0 |
| Ex. 51 | 95.0 | 95.0 | 6.8 |
| Ex. 52 | 94.9 | 94.7 | 6.5 |
| Ex. 53 | 94.3 | 94.3 | 6.3 |
| Ex. 54 | 95.4 | 95.5 | 7.1 |
| Ex. 55 | 95.0 | 95.3 | 6.7 |
| Ex. 56 | 94.5 | 94.9 | 6.3 |

TABLE 4C

| | High rate discharge | | |
|---|---|---|---|
| | characteristics | Recovery rate | Gas amount |
| | 2 C/0.5 C | after storage | after storage |
| | (%) | (%) | (ml) |
| Ex. 57 | 95.1 | 95.5 | 6.8 |
| Ex. 58 | 95.3 | 95.2 | 7.1 |
| Ex. 59 | 95.2 | 94.8 | 6.7 |
| Ex. 60 | 94.6 | 95.6 | 7.0 |
| Ex. 61 | 95.2 | 95.0 | 6.3 |
| Ex. 62 | 95.1 | 94.8 | 6.3 |
| Ex. 63 | 95.1 | 95.6 | 6.6 |
| Ex. 64 | 94.9 | 95.1 | 6.7 |
| Ex. 65 | 95.2 | 94.7 | 6.8 |
| Ex. 66 | 94.6 | 94.7 | 7.1 |
| Ex. 67 | 95.4 | 94.7 | 6.7 |
| Ex. 68 | 95.2 | 95.5 | 7.0 |
| Ex. 69 | 95.3 | 94.9 | 6.4 |
| Ex. 70 | 94.6 | 95.0 | 6.9 |
| Ex. 71 | 94.8 | 95.5 | 6.5 |
| Ex. 72 | 95.1 | 95.0 | 6.3 |
| Ex. 73 | 95.4 | 94.7 | 7.2 |
| Ex. 74 | 94.9 | 95.0 | 7.1 |
| Ex. 75 | 94.7 | 95.2 | 6.3 |
| Ex. 76 | 94.6 | 94.7 | 7.0 |

TABLE 4D

| | High rate discharge | | |
|---|---|---|---|
| | characteristics | Recovery rate | Gas amount |
| | 2 C/0.5 C | after storage | after storage |
| | (%) | (%) | (ml) |
| Ex. 77 | 95.0 | 94.7 | 7.1 |
| Ex. 78 | 94.9 | 95.4 | 7.1 |
| Ex. 79 | 94.4 | 94.9 | 7.0 |
| Ex. 80 | 94.5 | 95.4 | 7.0 |
| Ex. 81 | 94.4 | 95.3 | 6.6 |
| Ex. 82 | 94.7 | 95.4 | 7.1 |
| Ex. 83 | 95.1 | 95.2 | 6.5 |
| Ex. 84 | 94.9 | 94.9 | 6.9 |
| Ex. 85 | 95.3 | 94.8 | 7.1 |
| Ex. 86 | 95.2 | 95.3 | 6.5 |
| Ex. 87 | 94.7 | 95.0 | 6.6 |
| Ex. 88 | 95.3 | 95.5 | 7.2 |
| Ex. 89 | 95.1 | 95.5 | 7.0 |
| Ex. 90 | 94.5 | 95.5 | 6.9 |
| Ex. 91 | 95.0 | 94.9 | 6.4 |
| Ex. 92 | 95.0 | 95.2 | 6.6 |
| Ex. 93 | 94.7 | 95.5 | 6.7 |
| Ex. 94 | 94.4 | 94.9 | 7.2 |
| Ex. 95 | 94.5 | 95.3 | 6.9 |
| Ex. 96 | 94.9 | 95.1 | 6.7 |
| Ex. 97 | 95.0 | 95.1 | 7.0 |
| Ex. 98 | 94.9 | 95.4 | 6.4 |

TABLE 4E

| | High rate discharge | | |
|---|---|---|---|
| | characteristics | Recovery rate | Gas amount |
| | 2 C/0.5 C | after storage | after storage |
| | (%) | (%) | (ml) |
| Ex. 99 | 94.9 | 95.7 | 6.5 |
| Ex. 100 | 94.9 | 95.0 | 7.4 |
| Ex. 101 | 94.7 | 95.4 | 6.6 |
| Ex. 102 | 94.8 | 95.4 | 6.6 |
| Ex. 103 | 94.4 | 95.3 | 7.5 |
| Ex. 104 | 95.2 | 95.0 | 6.8 |
| Ex. 105 | 95.4 | 95.7 | 6.8 |
| Ex. 106 | 94.8 | 94.7 | 6.7 |
| Ex. 107 | 95.3 | 95.1 | 7.2 |
| Ex. 108 | 95.4 | 95.3 | 6.8 |
| Ex. 109 | 94.5 | 95.6 | 6.7 |
| Ex. 110 | 94.6 | 95.1 | 7.0 |
| Ex. 111 | 94.4 | 95.2 | 7.4 |
| Ex. 112 | 95.3 | 95.7 | 7.3 |
| Ex. 113 | 95.3 | 95.1 | 6.8 |
| Ex. 114 | 95.3 | 95.6 | 6.9 |
| Ex. 115 | 94.7 | 94.8 | 7.2 |
| Ex. 116 | 94.4 | 95.5 | 6.8 |
| Ex. 117 | 95.1 | 95.1 | 7.3 |
| Ex. 118 | 94.9 | 94.9 | 6.6 |
| Ex. 119 | 94.5 | 95.1 | 6.7 |

TABLE 4F

| | High rate discharge | | |
|---|---|---|---|
| | characteristics | Recovery rate | Gas amount |
| | 2 C/0.5 C | after storage | after storage |
| | (%) | (%) | (ml) |
| Ex. 120 | 95.1 | 95.2 | 6.9 |
| Ex. 121 | 95.3 | 94.6 | 7.2 |
| Ex. 122 | 94.7 | 94.8 | 6.6 |
| Ex. 123 | 94.7 | 95.4 | 6.6 |
| Ex. 124 | 95.1 | 94.6 | 6.6 |
| Ex. 125 | 94.5 | 95.2 | 6.7 |
| Ex. 126 | 94.7 | 94.6 | 7.1 |
| Ex. 127 | 94.8 | 94.8 | 7.2 |
| Ex. 128 | 94.7 | 95.5 | 6.5 |
| Ex. 129 | 94.4 | 94.6 | 7.4 |
| Ex. 130 | 94.6 | 95.1 | 7.3 |
| Ex. 131 | 94.6 | 95.5 | 7.1 |
| Ex. 132 | 94.6 | 95.2 | 7.2 |

As shown in Tables 4A to 4F, the amount of gas generated during storage (i.e. gas amount after storage) for the batteries of EXAMPLEs 9 to 132 was smaller than that for the battery of COMPARATIVE EXAMPLE 1 containing no bromine compound. Moreover, all the batteries of EXAMPLEs 9 to 132 were excellent in terms of discharge capacity after storage and recovery rate. Further, they were also excellent in terms of safety, high rate discharge characteristics and cycle characteristics, similar to the batteries of EXAMPLEs 1 to 8.

It is to be noted that, although some bromine compounds were detailed in the above examples, a similar effect can be obtained by using any of the bromine compounds represented by the formulas (1) to (17).

Further, although the above examples were described using a lithium ion secondary battery, a similar effect can be obtained by using other non-aqueous electrolyte secondary battery such as polymer secondary battery using a gel electrolyte, magnesium secondary battery, aluminum secondary battery and sodium secondary battery.

Further, although the above examples were described using a battery including an electrode group in which the positive electrode and the negative electrode were spirally wound with the separator interposed therebetween, the structure of the electrode group of the battery is not limited thereto. A similar effect can be obtained in a battery containing an electrode group in which the positive electrodes and the negative electrodes are stacked.

Further, the shape of the non-aqueous electrolyte secondary battery is not limited to the cylindrical battery used in the above examples. A similar effect can be obtained in a prismatic or coin type battery using a battery can as the case, or a sheet type battery using an aluminum laminate film as the case.

As described above, according to the present invention, it is possible to prevent the temperature of the battery from increasing and to suppress the gas generation when the battery in a charged state is stored at high temperatures. Further, it is also possible to obtain excellent battery characteristics after storage and excellent cycle characteristics. Therefore, according to the present invention, it is possible to provide a highly-reliable non-aqueous electrolyte secondary battery excellent in safety. The non-aqueous electrolyte secondary battery of the present invention is applicable as a power source for driving electronics such as laptop computers, cell phones and digital still cameras.

Although the present invention has been described in terms of the presently preferred embodiments, it is to be understood that such disclosure is not to be interpreted as limiting. Various alterations and modifications will no doubt become apparent to those skilled in the art to which the present invention pertains, after having read the above disclosure. Accordingly, it is intended that the appended claims be interpreted as covering all alterations and modifications as fall within the true spirit and scope of the invention.

1. A non-aqueous electrolyte secondary battery comprising:
an electrode group,
a non-aqueous electrolyte and
a case accommodating said electrode group and said non-aqueous electrolyte,
said electrode group comprising a positive electrode, a negative electrode and a separator interposed between said positive electrode and said negative electrode,
said non-aqueous electrolyte containing a bromine compound having an aromatic ring, wherein
said bromine compound is represented by any one of the following chemical formulas (1) to (17): 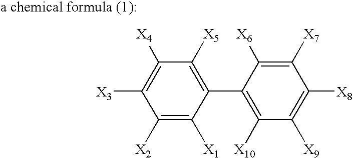
where X₁ to X₁₀ each independently represent a bromine atom or hydrogen atom, and at least one of them is a bromine atom; 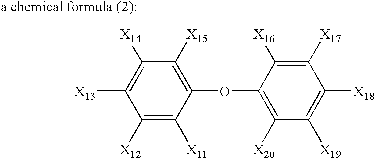
where X₁₁ to X₂₀ each independently represent a bromine atom or hydrogen atom, and at least one of them is a bromine atom; 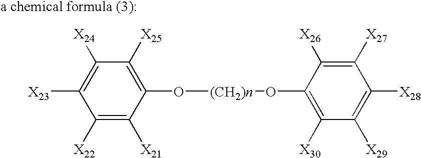
where X₂₁ to X₃₀ each independently represent a bromine atom or hydrogen atom, and at least one of them is a bromine atom, and
where n is 1 to 4; 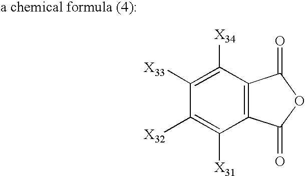
where X₃₁ to X₃₄ each independently represent a bromine atom or hydrogen atom, and at least one of them is a bromine atom; 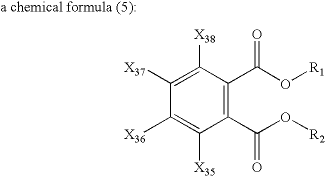
where X₃₅ to X₃₈ each independently represent a bromine atom or hydrogen atom, and at least one of them is a bromine atom, and
where R₁ and R₂ are each independently a group containing a carbon atom and at least one selected from the group consisting of hydrogen atom and oxygen atom, and the number of said carbon atoms is 1 to 6; 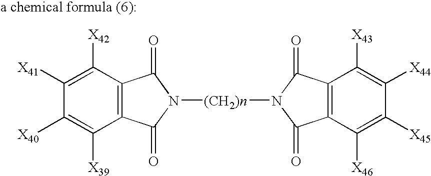
where X₃₉ to X₄₆ each independently represent a bromine atom or hydrogen atom, and at least one of them is a bromine atom, and
where n is 0 to 4; 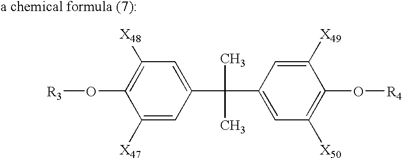
where X₄₇ to X₅₀ each independently represent a bromine atom or hydrogen atom, and at least one of them is a bromine atom, and
where R₃ and R₄ are each independently a group containing a carbon atom, a hydrogen atom and at least one selected from the group consisting of bromine atom and oxygen atom, and the number of said carbon atoms is 1 to 6; 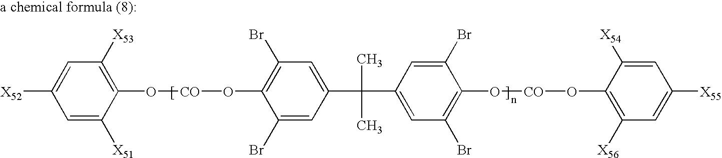
where X₅₁ to X₅₆ each independently represent a bromine atom or hydrogen atom, and at least one of them is a bromine atom, and
where n is 2 to 10; 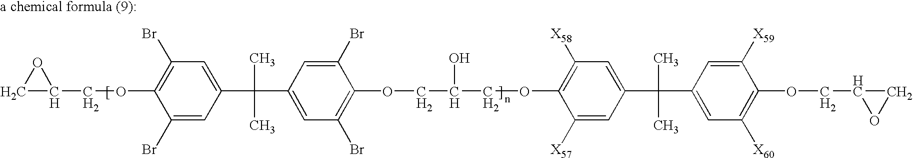
where X₅₇ to X₆₀ each independently represent a bromine atom or hydrogen atom, and at least one of them is a bromine atom, and
where n is 1 to 100; 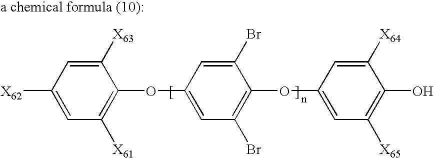
where X₆₁ to X₆₅ each independently represent a bromine atom or hydrogen atom, and at least one of them is a bromine atom, and
where n is 10 to 30; 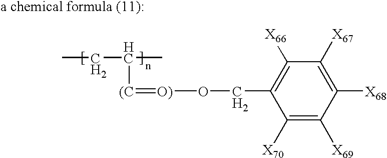
where X₆₆ to X₇₀ each independently represent a bromine atom or hydrogen atom, and at least one of them is a bromine atom, and
where n is 100 to 200; 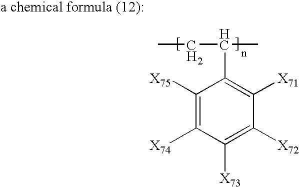
where X₇₁ to X₇₅ each independently represent a bromine atom or hydrogen atom, and at least one of them is a bromine atom, and
where n is 200 to 600; 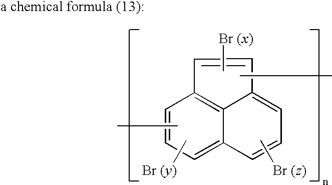
where x, y and z each represent the number of bromine atoms bonded to an aromatic ring, and the total of x, y and z is 1 to 6, and
where n is 1 to 5; 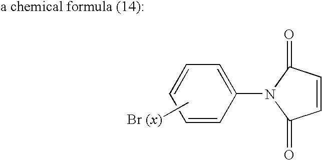
where x represents the number of bromine atoms bonded to an aromatic ring, and x is 1 to 5; 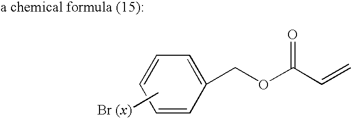
where x represents the number of bromine atoms bonded to an aromatic ring, and x is 1 to 5; 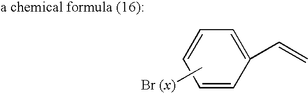
where x represents the number of bromine atoms bonded to an aromatic ring, and x is 1 to 5; and 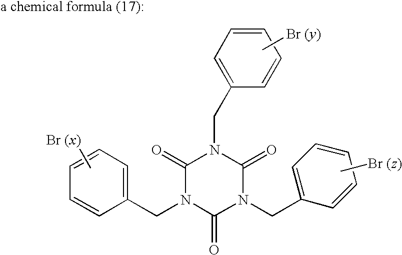
where x, y and z each represent the number of bromine atoms bonded to an aromatic ring, and x, y and z are each 1 to 5.

2. The non-aqueous electrolyte secondary battery in accordance with claim 1, wherein the amount of bromine atoms contained in said bromine compound is 0.003 to 0.1 mol/L relative to the amount of said non-aqueous electrolyte.
